(19) United States
(12) Patent Application Publication
(10) Pub. No.: US 2012/0218748 A1
(43) Pub. Date: Aug. 30, 2012

(54) LED LIGHT BULB

(75) Inventor: Wayne Ernest Conrad, Hampton (CA)

(73) Assignee: G.B.D. CORP., Nassau, BS (BS)

(21) Appl. No.: 13/505,248

(22) PCT Filed: Nov. 2, 2010
(86) PCT No.: PCT/CA2010/001743

§ 371 Date: Apr. 30, 2012

(30) Foreign Application Priority Data
Nov. 3, 2009 (CA) 2684301

(51) Int. Cl. F21V 21/00

(52) U.S. Cl. 362/230; 362/231; 362/249.02

(57) ABSTRACT

The alleged invention is directed to a LED light bulb capable of being installed in a light fixture/housing, the LED light bulb comprising a main body having a first end and a second end, at least one LED disposed within the second end of the main body, an electrical connector disposed at the second end of the main body and an adjustment member provided for adjusting the position of the second end of the main body with respect to a rim defining an opening in the light fixture/housing.

### FIELD OF THE INVENTION

The invention relates to light bulbs that utilize LEDs.

### BACKGROUND OF THE INVENTION

Various types of light bulbs are known. Traditionally, the light bulbs that have been used in many applications are incandescent light bulbs. More recently, halogen and fluorescent light bulbs have been adopted. These light bulbs are advantageous as they use a reduced amount of electricity. However, halogen light bulbs operate at relatively high temperatures. In addition, fluorescent light bulbs typically incorporate mercury vapour and provide disposal issues.

### SUMMARY OF THE INVENTION

This specification set out many developments relating to light bulbs that utilize LEDs including, a housing construction that uses a thin wall material, preferably polycarbonate; the provision of EMI shielding; a mechanical member to protect the LEDs when mounted in the housing; a construction for facilitating the mechanical gripping of the light bulb for installation and removal; a construction to enable the end of the light bulb containing the LEDs to seat at the desired position in a light bulb receptacle; LED selection based upon one or more of the operating characteristics of the LEDs such as operating voltage, current, beam angle of light output and/or color temperature, and an associated wiring layout; a front cover reflector; and, a construction to seal the light bulb from water ingress.

It will be appreciated that each of these features may be used individually or in any particular combination or sub-combination. Accordingly, a light bulb in accordance with this invention may use any one or more of these features.

### BRIEF DESCRIPTION OF THE DRAWINGS

These and other advantages of the present invention will be more fully and particularly understood in connection with the following description of the preferred embodiments of the invention in which:

FIG. 1 is a longitudinal cross section through a light bulb in accordance with one aspect of this invention;

FIG. 1a is a perspective view of the longitudinal cross section of FIG. 1;

FIGS. 1b and 1C each exemplify a method for mounting a circuit board in the light bulb housing in accordance with another aspect of this invention;

FIG. 2a is a perspective view of a light bulb with a construction for facilitating the mechanical gripping of the light bulb for installation and removal in accordance with another aspect of this invention;

FIG. 3a exemplifies a tool that may be used with the light bulb exemplified in FIG. 2a;

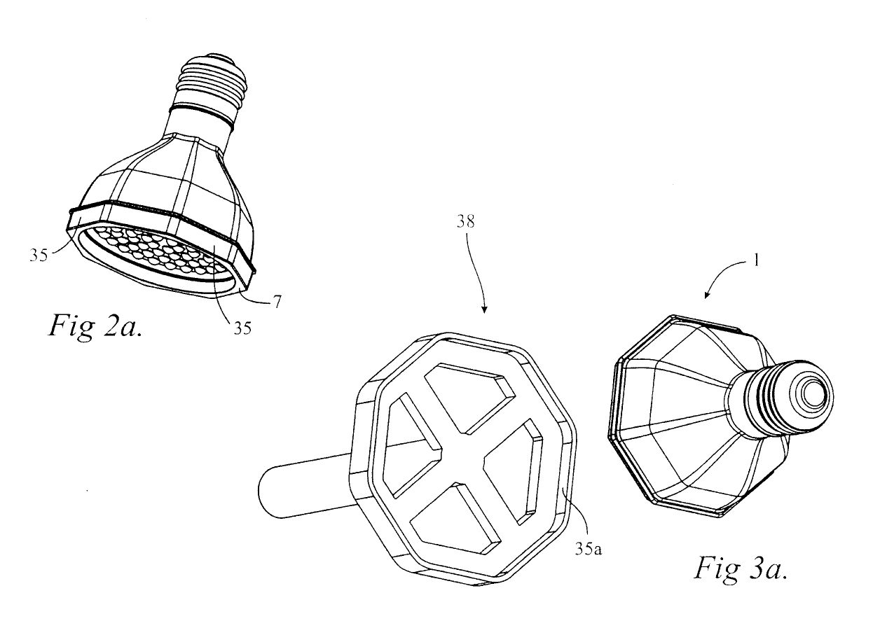

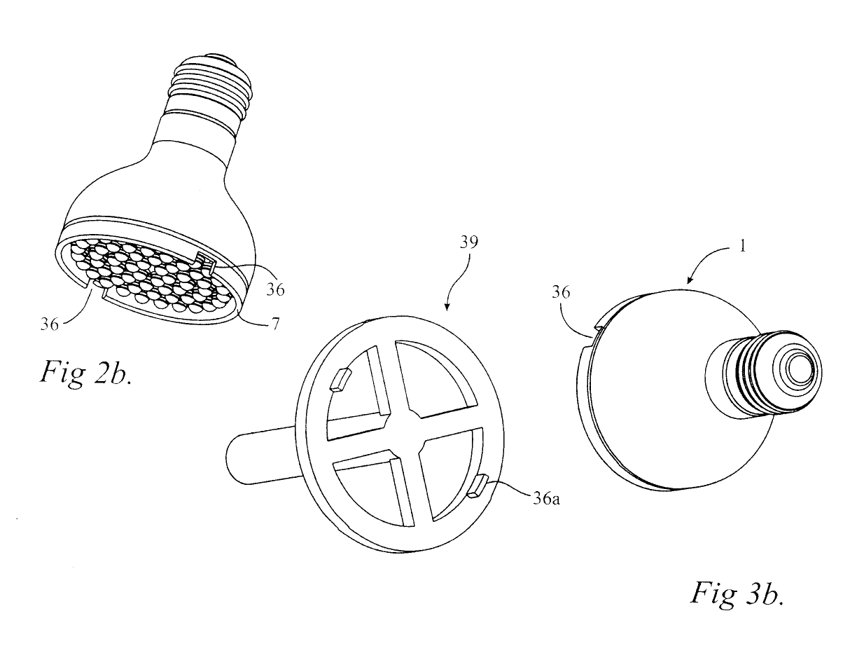

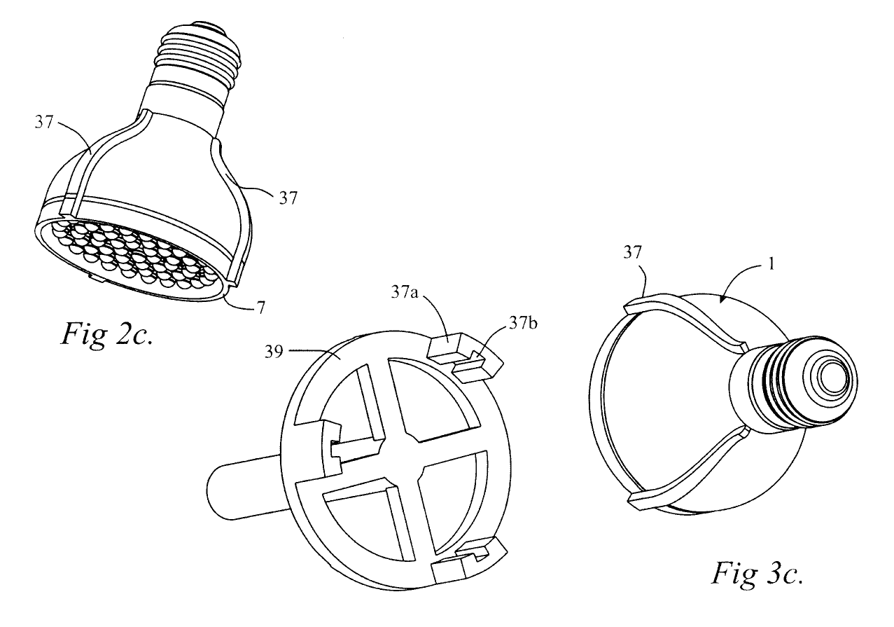

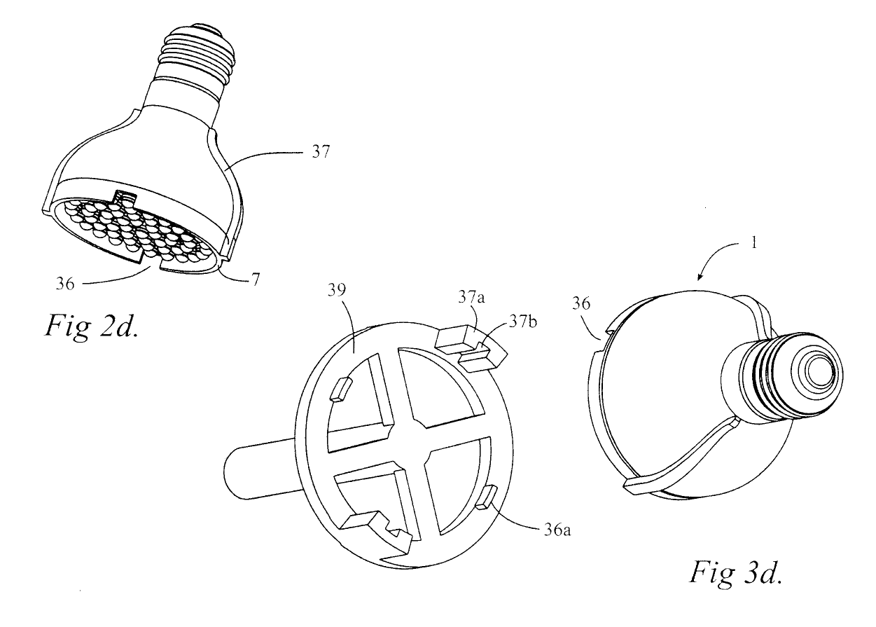

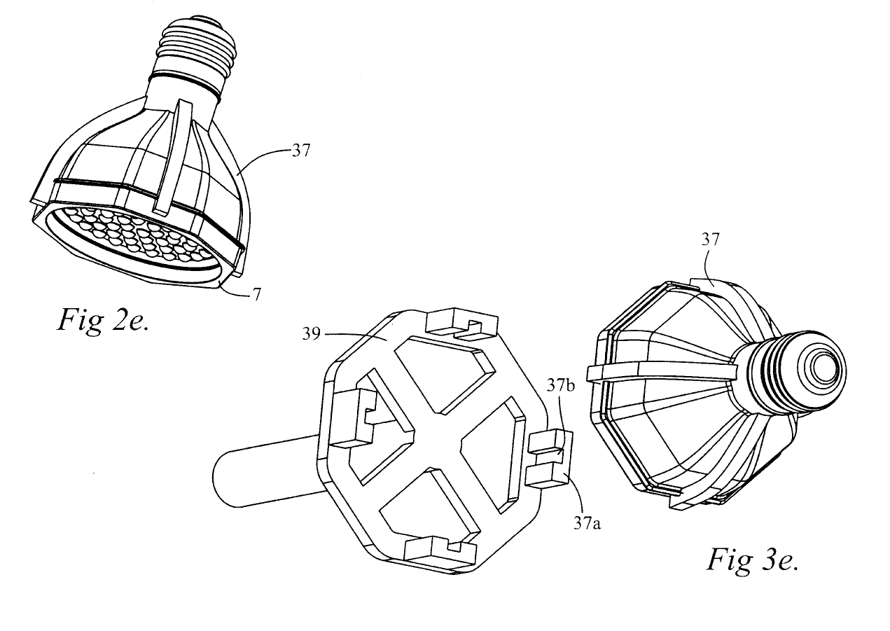

FIGS. 2b, 2c, 2d and 2e each is a perspective view of a light bulb with an alternate construction for facilitating the mechanical gripping of the light bulb for installation and removal;

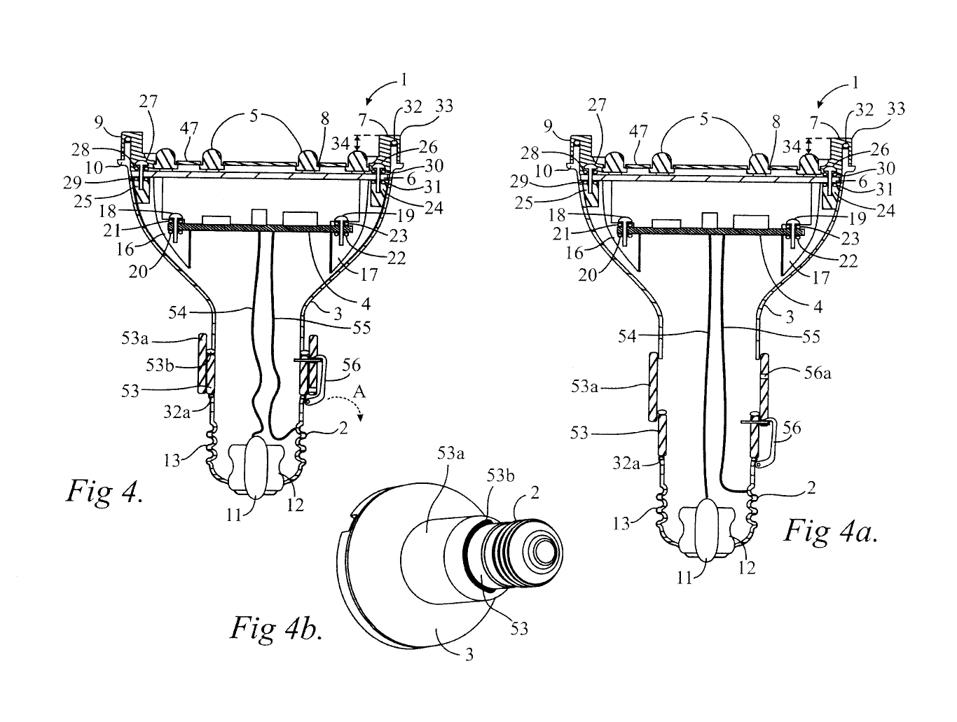

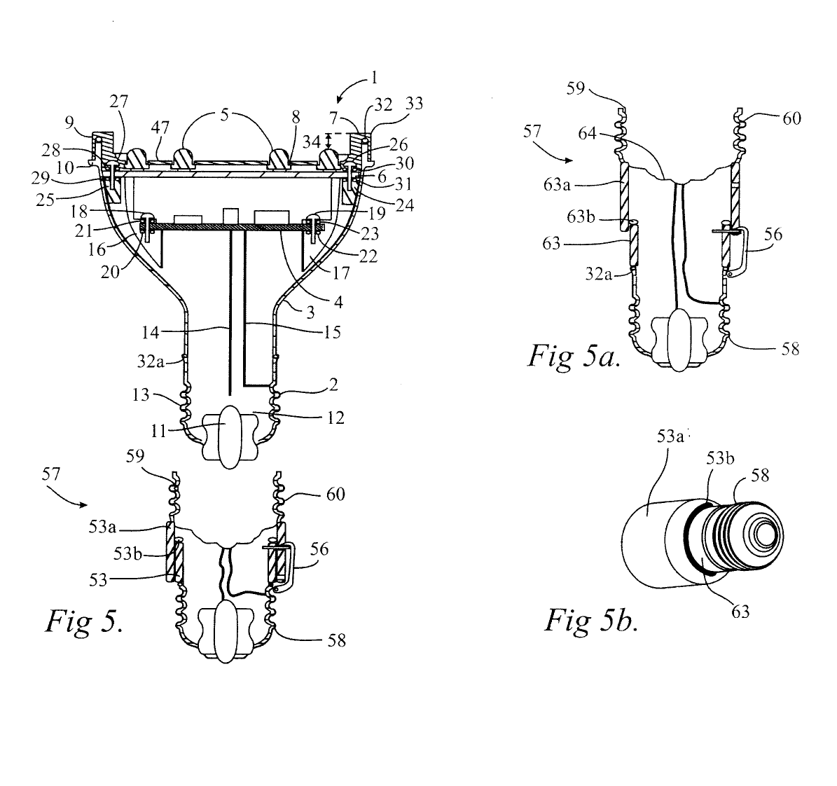

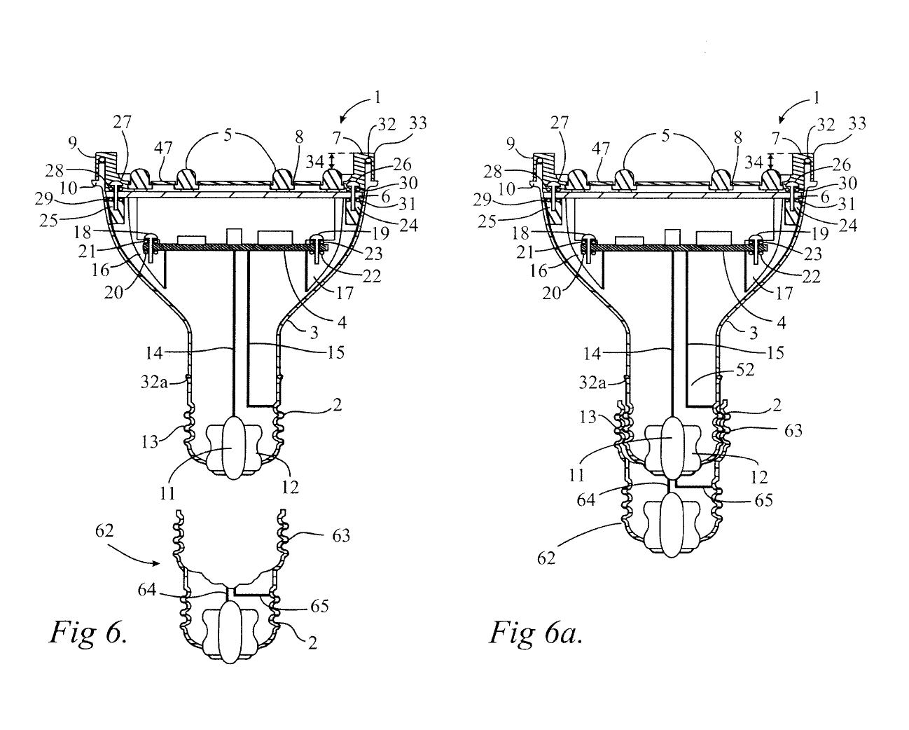

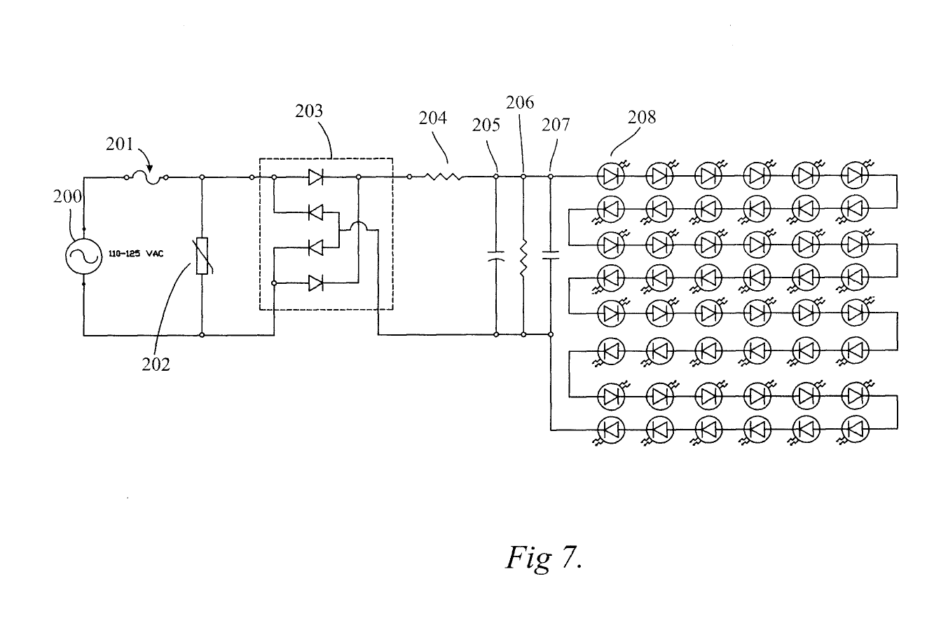

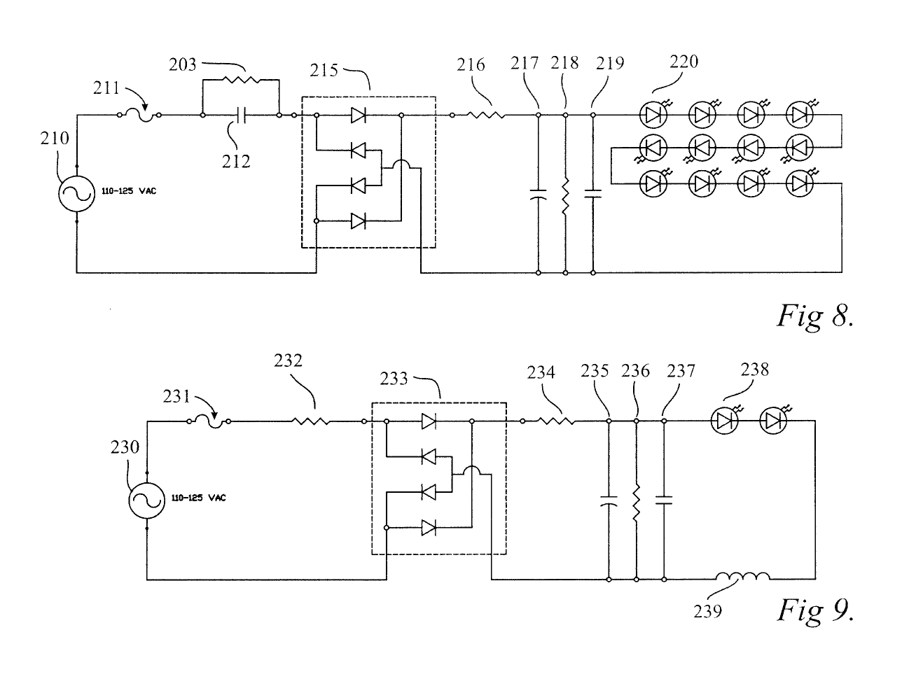

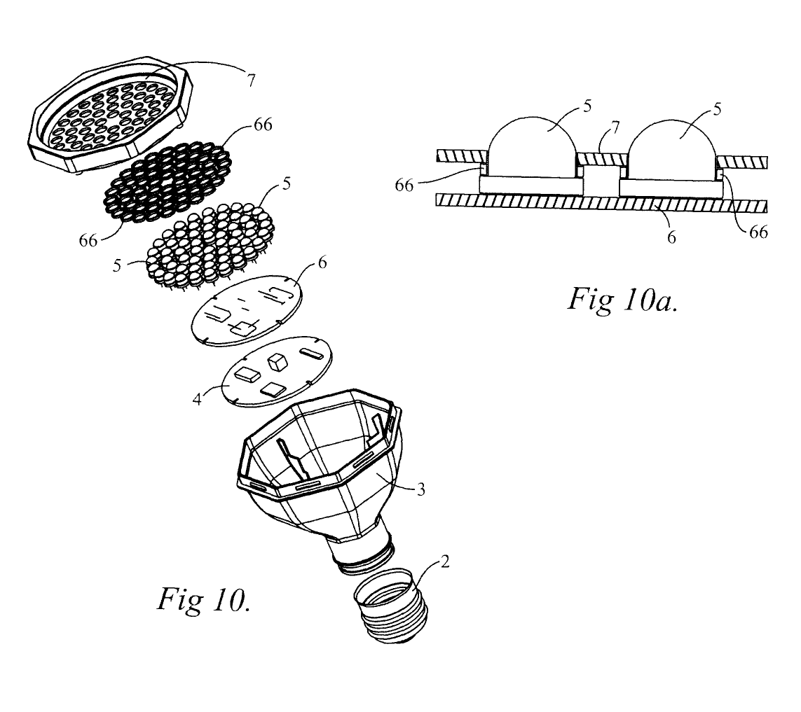

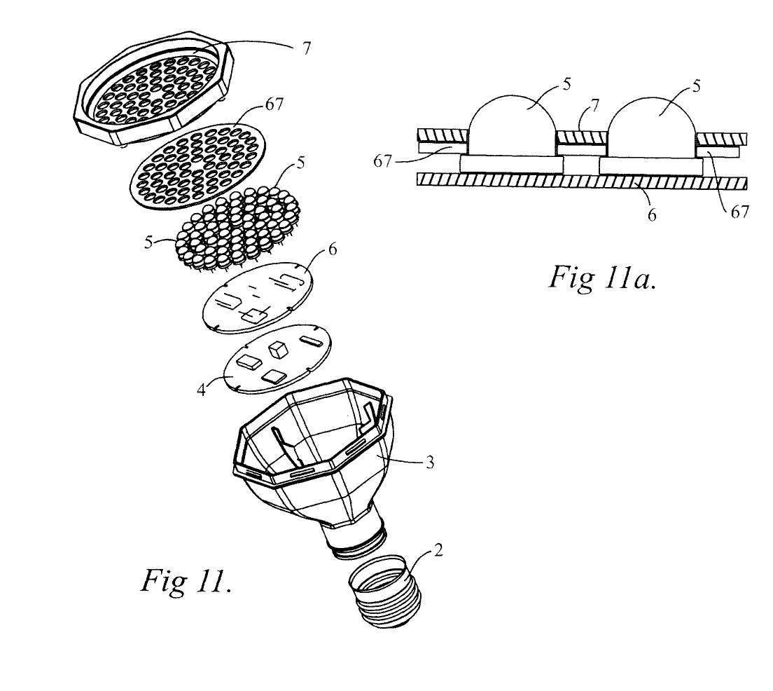

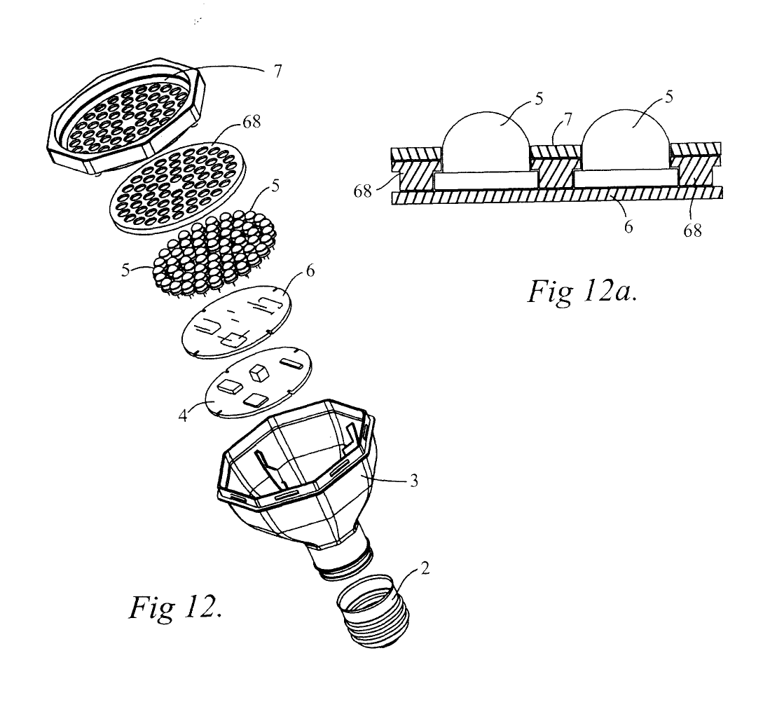

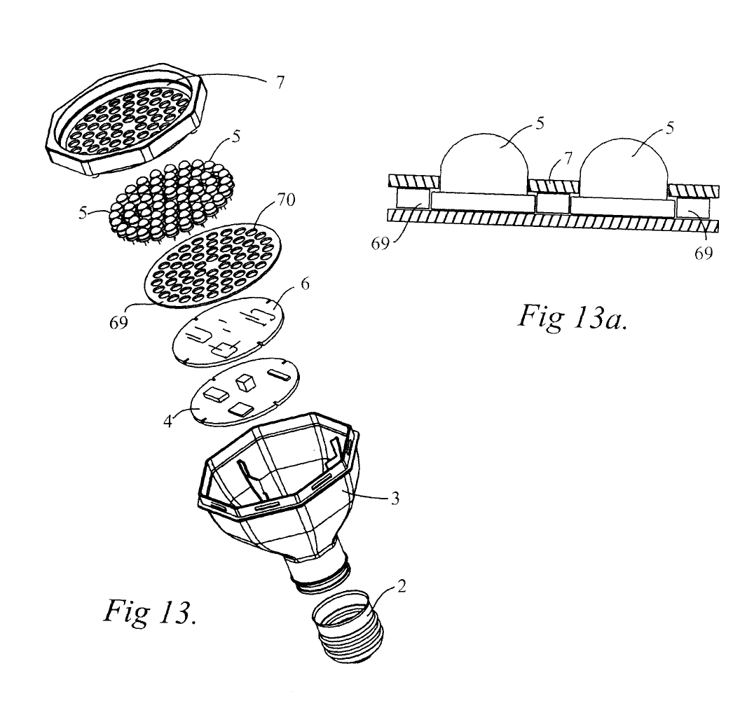

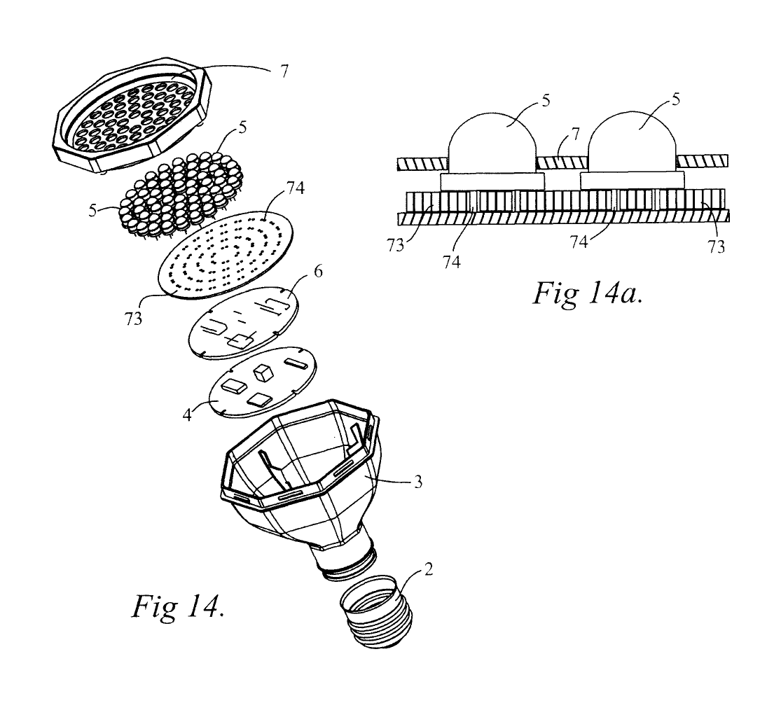

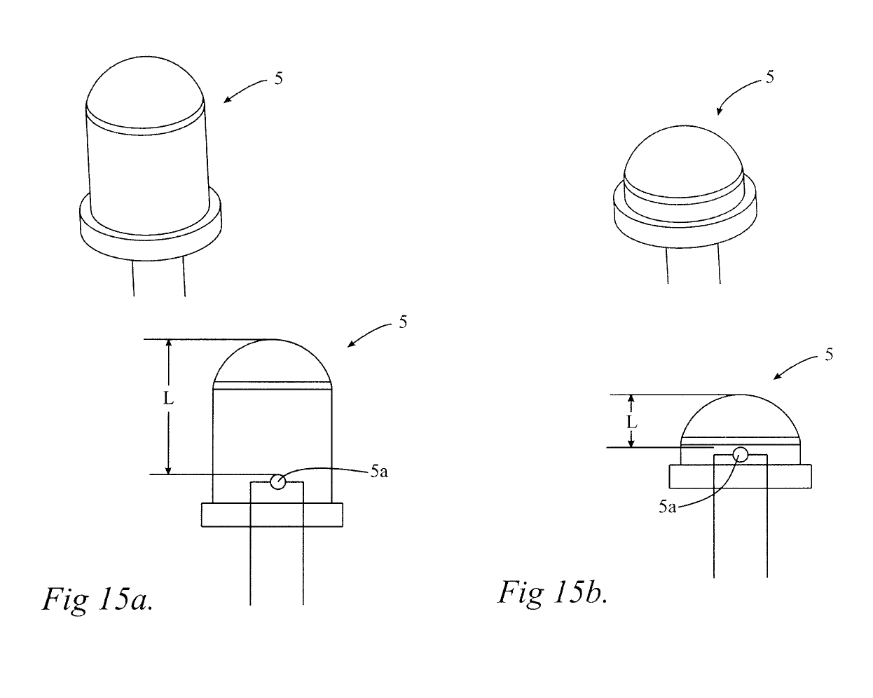

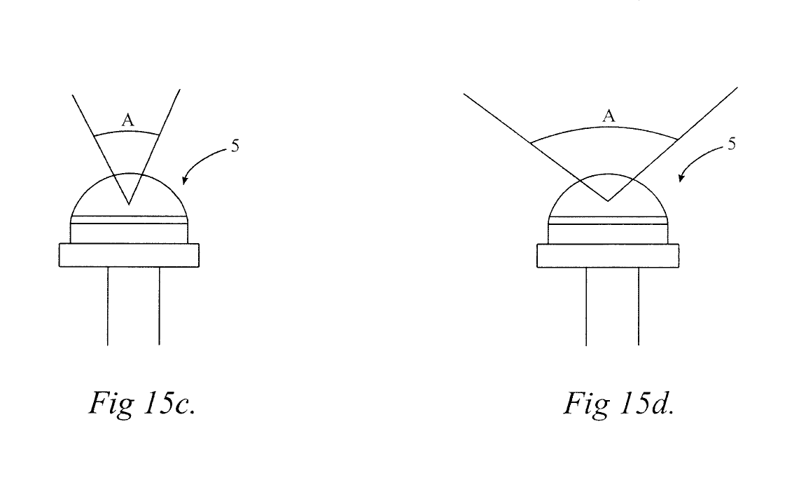

FIGS. 3b, 3c, 3d, 3e each exemplifies a tool that may be used with the light bulb respectively exemplified in FIGS. 2b, 2c, 2d and 2e;

FIGS. 4, 4a and 4b exemplify a construction to enable the end of the light bulb containing the LEDs to seat at the desired position in a light bulb receptacle in accordance with another aspect of this invention wherein in FIG. 4 the LED end of the light bulb is at a retracted position and in FIG. 4a the LED end of the light bulb is at an extended position;

FIGS. 5, 5a and 5b exemplify an alternate construction to enable the end of the light bulb containing the LEDs to seat at the desired position in a light bulb receptacle wherein in FIG. 5 the light bulb is removed from an extension member and the extension member is at a retracted position, and in FIG. 5a the extension member is shown in an extended position;

FIGS. 6 and 6a exemplify an alternate construction to enable the end of the light bulb containing the LEDs to seat at the desired position in a light bulb receptacle wherein in FIG. 6 the light bulb is removed from an extension member of fixed length, and in FIG. 6a the extension member is shown mounted to the light bulb such that the light bulb is in an extended position;

FIG. 7 shows a schematic wiring diagram for a light bulb in accordance with another aspect of this invention;

FIGS. 8 and 9 each show an alternate schematic wiring diagram for a light bulb in accordance with this invention;

FIGS. 10, 10a, 11, 11a, 12, 12a, 13, 13a, 14 and 14a exemplify different methods that may be used to seal a light bulb housing from the ingress of water in accordance with an alternate aspect of this invention;

FIG. 15a exemplifies a prior art LED; and

FIGS. 15b, 15c and 15d exemplify details of LEDs that may be used in accordance with another aspect of this invention;

### DETAILED DESCRIPTION OF THE INVENTION

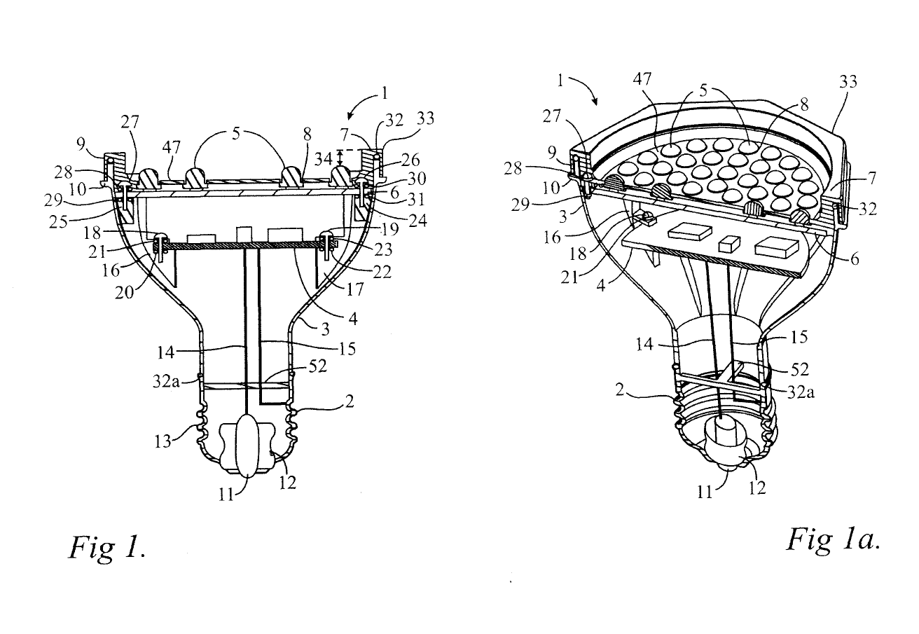

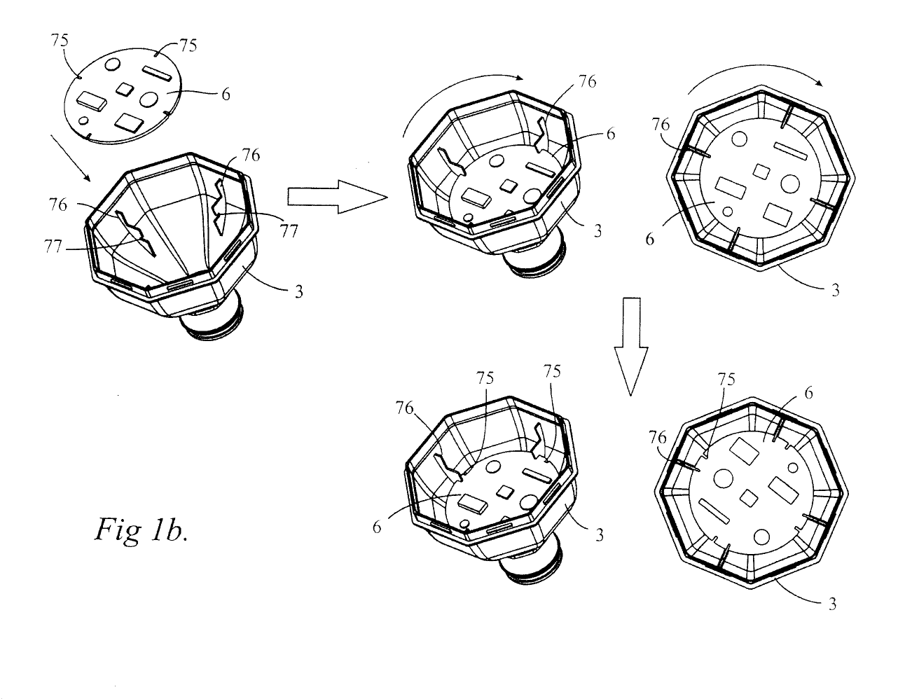

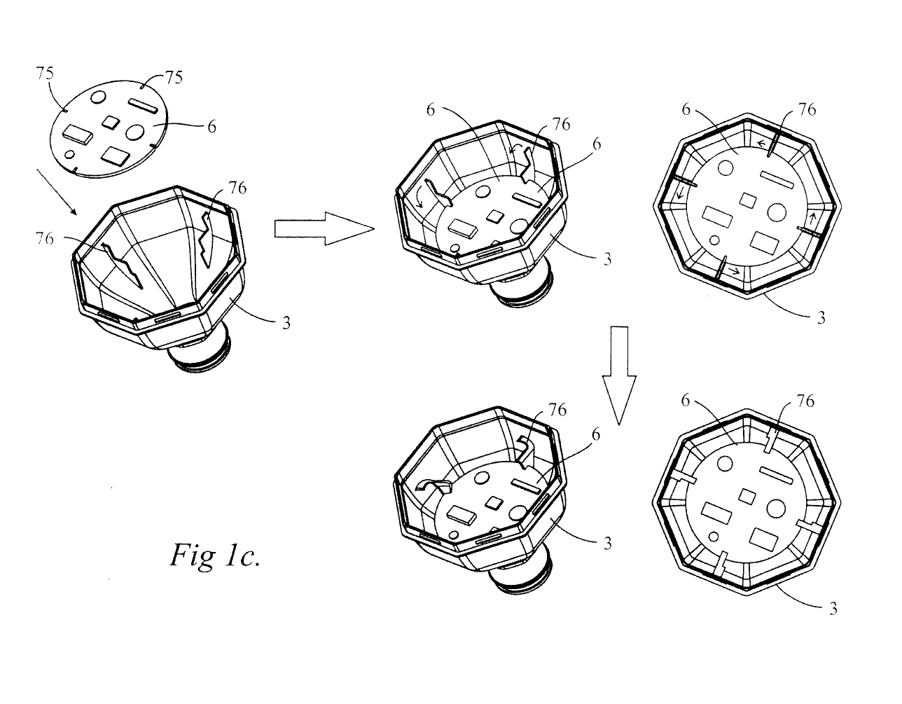

A construction for a LED light bulb is exemplified in FIGS. 1 and 1a. As exemplified therein, bulb assembly 1 consists of a threaded electrical connector 2, a main body 3, an electrical power supply 4, at least one, and preferably a plurality of LEDs 5 connected, e.g., soldered, to an LED circuit or power supply board 6, such as a mounting printed circuit board 6. It will be appreciated that the shape, configuration and method of manufacture of bulb assembly 1 may be of any design in the art. For example, threaded electrical connector 2 may be of any type used with light bulbs and main body 3 may be of any shape and style.

A member, such a front cover 7, is preferably provided to overlie power supply board 6. Accordingly, power supply board 6 may be isolated from the environment by front cover 7. Referring to the preferred embodiment of FIGS. 1 and 1a, front cover 7 may comprise a web having holes 8 whose position corresponds to the positions of LEDs 5 on the printed circuit board 6. It will be appreciated that a front cover 7 may comprise a single molded member or a plurality of members that combine to provide a continuous cover over the sensitive part, and preferably all, of board 6. It will be appreciated that FIG. 1 exemplifies a front cover in accordance with one embodiment of this invention. In other embodiments, front cover 7 may be a flat plate without raised flanges 9.

Front cover 7 may be of any design and may be secured in position by any means known in the art, such as by being secured or releasably secured to main body 3. For example, front cover 7 may be secured to main body 3 by an adhesive, by a screw or bayonet mount, a snap fit or, as exemplified, by means of a physical fixation member, such as screws 18, 19, or the like.

Preferably, light bulb 1 includes male and female members 9, 10, which interact to secure front cover 7 in position. For example, the male mounting member 9, may be a longitudinally extending flange that is part of main body 3, which is received in female mounting member 10, which may be a recess in front cover 7. Male and female mounting members 9, 10 may be sized to retain male mounting member 9 in female mounting member, e.g., a running locking fit. Alternately, or in addition, male and female mounting members 9, 10 may be configured to retain male mounting member 9 in female mounting member, e.g., by means of engagement members on the longitudinally extending abutting surfaces. Alternately, or in addition, an adhesive and or screws or rivets or the like may be used. Accordingly flange 9 and recess 10 comprise first and second engagement members.

Optionally, a securing member 32 may be an O-ring or a ring of adhesive silicone or other adhesive member that assists in sealing and attaching main body 3 and the front cover 7 together may be provided. In such a case, flange 9 and recess 10 need not comprise first and second engagement members but may merely be mounting members. Securing member 32 also serves to absorb the shock of impact when the product is dropped and to help absorb mechanical vibration when the light bulb assembly 1 is installed into fans, elevators, garage door openers or other environments where the bulb assembly 1 will be subjected to mechanical vibration.

It will be appreciated that the use of flanges that extend longitudinally past the tip of LEDs 5 (i.e. the portion of the LED that reference numeral 5 points to in FIG. 1) is an embodiment that is used in one aspect of this invention and may be used by itself or with any one or more other embodiments contained herein.

The main body 3 may optionally incorporate one or more cross member ribs 52 to support the end of the bulb where the threaded electrical connector 2 is attached.

The threaded electrical connector 2 may be any such member known in the lighting arts. As exemplified, it preferably comprises an electrically conductive connection point 11, an insulating member 12, and an electrically conductive connection thread 13. Two electrically insulated wires 14 and 15 connect the electrically conductive connection point 11, and the electrically conductive connection thread 13 respectively to the power supply 4. It will be appreciated that electrical connector 2 may alternately use any other design that is receivable in a light fixture and need not be confined to a screw thread. For example, a bayonet mount may be used.

The electrical power supply 4 may be secured, or releasably secured to main body 3 by an adhesive, such as flexible silicone or epoxy, and/or by one or more mechanical securing members such as screw, rivets or the like. As exemplified, mechanical securing members are used. Accordingly, main body 3 is provided with a mount or base on which electrical power supply 4 is seated, such as flanges, 16 and 17. Flanges, 16 and 17 may be integrally molded with, welded to, or mechanically affixed to main body 3 to serve as a base of anchoring the electrical power supply 4 and may be provided with screw ports. Screws 18 and 19 may preferably be used to affix the electrical power supply 4 to flanges 16 and 17.

Preferably, O-rings or other cushioning material 20, 21, 22, 23 may be used with the mounting member (e.g., screws 16, 17 and flanges 16, 17) to mount the electrical power supply 4 while mechanically insulating it from vibration. Alternate mounting means may be used such as a screw fit, a snap fit or the like.

The LED mounting printed circuit board 6 may be mounted to main body 3 by any of the means that may be used to mount power supply 4 to main body 3. For example, board 6 may be mechanically adhered to the main body 3 by means of an adhesive such as flexible silicone or epoxy. Alternatively, or in addition, one or more members such as mechanical mounting members 24 and 25 may be integrally molded with, welded to, or mechanically affixed to the main body 3 to serve as a means of anchoring the LED mounting printed circuit board 6. Preferably, screws 26 and 27 affix the LED mounting printed circuit board 6 to the members, e.g., flanges, 24 and 24, which may be provided with screw ports. An O-ring or other cushioning material 28, 29, 30 and 31 may optionally be used with the mounting member (e.g., the screws and flanges) to mount the LED mounting printed circuit board 6 while mechanically insulating it from vibration. The mounting of the electrical power supply 4 and the LED mounting printed circuit board 6 may optionally share common mounting members.

It will be appreciated that other configurations of a light bulb may be used provided the light bulb is receivable in an electrical housing and a mount for LEDs5 is provided.

In accordance with one embodiment, which may be used by itself or with any combination of embodiments disclosed herein, LEDs 5 are preferably arranged, e.g., mounted to the LED mounting printed circuit board 6, in a pattern that provides an even dispersal of light. Preferably, a spacing of at least 0.010″ (e.g., 0.010-0.100″) is provided between adjacent, and preferably each adjacent, LED bulb 5. More preferably the spacing is at least 0.040″ (e.g., 0.040-0.100″), and most preferably the spacing is 0.080″-0.100″.

In accordance with another embodiment, which may be used by itself or with any combination of embodiments disclosed herein, guide members may be provided to align board 6 and/or power supply 4 to main body 3. Optionally, these guide members may be used to secure the board/power supply to main body 3. As exemplified in FIG. 1b, a series of notches 77 are provided in a series of internal ribs 76, which may be integrally molded with a main body 3. A series of mating notches 75 are provided in a printed circuit board 6. The circuit board 6 may therefore slide down ribs 76 and rotate in either direction. An alternate design is shown in FIG. 1c. As exemplified therein, ribs 6 are deformable after board 6 is positioned thereon. Accordingly, board 6 may slide down ribs 76 and ribs 76 may thereafter be bent to insure that the circuit board 6 cannot slide back up the ribs 76.

It will be appreciated that alternate alignment members may be used. The alignment members are configured to enable or permit the board 4, 6 to be inserted in only one or only selected orientations. For example, a key and slot or other alignment members may be used. This method of mounting a circuit board may also be employed if the electronics are not all mounted on the rear surface of the LED mounting printed circuit board 6.

In accordance with another embodiment, which may be used by itself or with any combination of embodiments disclosed herein, main body 3 and/or front cover 7 are made of plastic such as a fire retardant ABS, polycarbonate or other structural plastic to which a flame retardant is added to achieve a UL94V0 rating. The plastic is preferably polycarbonate. Alternately, or in addition, main body 3 preferably has a wall thickness of 0.060″ to 0.150″, more preferably 0.070″ to 0.125″ and most preferably 0.080″ to 0.090″.

Polycarbonate is a UL94V0 fire retardant material without requiring additional additives. In addition, the thickness range of 0.080-0.090″ provides a maximum strength to material weight ratio and is a thickness that cannot typically be molded in other plastics thereby avoiding mistakes in production wherein the wrong plastic is used to mold the parts. In addition, polycarbonate maintains its strength over a wide range of temperatures and is resistant to degradation by ultraviolet light such as exposure to sunlight. The polycarbonate parts may be mechanically fit together in a manner which ensures that there is no mechanical stress on the joints which would make the polycarbonate subject to cracking and damage from thermal cyclic loading, thermal expansion, or mechanical shock or a combination thereof.

In accordance with another embodiment, which may be used by itself or with any combination of embodiments disclosed herein, the interior and/or exterior surface of the a main body 3 and/or the front cover 7 may optionally have an electrically conductive layer applied, such as by means of a solvent paint, vapor deposition, thermal spray, electroplating, or other means, so as to create a layer to provide EMI shielding. Alternatively, or in addition, the plastic may have embedded metallic or carbon particles to create conductivity to provide EMI shielding.

The electrical connector 2 that is receivable in a light fixture and the main body 3 are preferably mechanically fit together in any manner which ensures that there is no or minimal mechanical stress on the joints which would make the polycarbonate subject to cracking and damage from thermal cyclic loading, thermal expansion, or mechanical shock or a combination thereof.

Optionally, or in addition, electrical connector 2 and the main body 3 may be secured together by securing member 32a, which may be an O-ring or a ring of adhesive silicone or other adhesive member. Securing member 32a preferably also serves to absorb the shock of impact if light bulb assembly 1 is dropped and to help absorb mechanical vibration if light bulb assembly 1 is installed into fans, elevators, garage door openers or other environments where the bulb assembly 1 will be subjected to mechanical vibration.

In accordance with another embodiment, which may be used by itself or with any combination of embodiments disclosed herein, the end of light bulb 1 where LEDs 5 are positioned is provided with one or more mechanical members that is positioned spaced above the tip of LEDs 5 (i.e. the portion of the LED that reference numeral 5 points to in FIG. 1). For example, the mechanical members may be safety edge 33 of front cover 7. Safety edge 33 makes the front cover rigid and strong and preferably flat and provides mechanical protection for the LEDs 5 which are recessed lower than the safety edge a shown by distance 34. The distance 34 may be at least 0.010″, preferably 0.010″ to 1.0″, more preferably 0.050 to 0.25″ and most preferably 0.100″ to 0.200″. It will be appreciated that edge 33 need not be continuous and the mechanical members may comprise a series of posts extending upwardly from board 6 and/or cover 7 and/or main body 3.

In accordance with another embodiment, which may be used by itself or with any combination of embodiments disclosed herein, light bulb 1 is configured to facilitate the insertion and/or removal of light bulb 1 from an electrical receptacle. Accordingly, light bulb 1 is provided with engagement surfaces. Preferably optional gripping tool 38, 39 is provided that has mating engagement surfaces. These engagement surfaces interact thereby allowing gripping tool 38, 39 to, e.g., rotate light bulb 1 in a light fixture. Different embodiments are exemplified in FIGS. 2a and 3a, 2b and 3b, 2c and 3c, 2d and 3d, and 2e and 3e.

For example, main body 3 of light bulb assembly 1 may incorporate one or more flats 35 as shown in FIG. 2a (e.g., the outer perimeter of light bulb 1 may be polygonal), notches 36 as shown in FIG. 2b, ribs 37 as shown in FIG. 2c or any combination thereof as shown in FIG. 2d.

Gripping tool 38, 39 is provided with one or more engagement surfaces such as inner wall 35a that seats over flats 35, tab 36a that is receivable in slot 36 or flange 37a having a slot 37b or a combination thereof.

The gripping members 35, 36, 37 provide one or more engagement surfaces for gripping the light bulb 1 during installation and de-installation using a hand or by using a mechanical tool 38, 39 shown in FIGS. 3a, 3b, 3c, 3d and 3e.

The gripping members 35, 36, 37 also provide mechanical strength to the main body 3, the front cover 7, and to the light bulb assembly 1. The gripping members 35, 36, 37 also provide a means of locating the light bulb assembly 1 within packaging to minimize damage and to minimize secondary layers of packaging to help maintain the location of the light bulb assembly 1 within packaging.

In accordance with another embodiment, which may be used by itself or with any combination of embodiments disclosed herein, light bulb 1 may be provided with a construction that permits the length of the light bulb to be adjusted. As exemplified in FIGS. 4, 5 and 6, the construction may be incorporated into light bulb 1 or may be a separate part. Accordingly, the outer end of light bulb 1 (i.e., the end of light bulb 1 distal to connector 2, e.g., the end with LEDs 5), may be seated at a desired position with respect to a light housing in which it may be inserted. Accordingly, even if light bulb 1 is shorter than a standard light bulb, it may be adjusted so that the the outer end is adjacent the rim of a light fixture in which it is placed.

For example, light bulb assembly 1, shown in FIGS. 4, 4a and 4b comprises a mechanical extension 53 and 53a that links the threaded electrical connector 2 to the main body 3. A length of electrically insulated wires 54 and 55 provide a flexible, extendable electrical connection between the threaded electrical connector 2 and the electrical power supply 4.

Mechanical extension 53 and 53a may be a series of telescoping cylinders. As exemplified, inner cylinder 53 is telescopically receivable in outer cylinder 53a. Optional seal 53b, which may be an O-ring, such that cylinders 53 and 53a are sealed to isolate the inside of main body 3 from the environment.

A lock is preferably provided to secure cylinders 53 and 53a in a desired configuration. As exemplified, a user releasable lock member 56 may be used to permit the distance between the threaded electrical connector 2 and the main body 3 to be adjusted and then fixed. For example, a user may rotate lock member 56 that may be pivotally mounted to cylinder 53 or connector 2 outwardly in the direction of arrow A in FIG. 4, to disengage the distal end of lock 56 from a flange 56a provided on cylinder 53a. The user may then telescopically extend mechanical extension 53a to a desired length. The user may then move the distal end of lock 56 so it engages another flange and lock the telescoping cylinders in a telescopically extended position.

FIGS. 5, 5a and 5b exemplify another optional design for extending the position of the LED light bulb by means of an separate mechanical extension 57. This design may operate in the same manner as the design of FIGS. 4, 4a and 4b. In this instance, the mechanical extension 57 is a separate member and is not constructed integrally with light bulb 1. Mechanical extension 57 may be removably mounted to light bulb 1 by any means. As exemplified, mechanical extension 57 has an electrical connector 58 receivable in a light fixture (e.g., a male threaded section 2), and is adapted to removably receive light bulb 1. For example, it may have a female threaded electrical connector 59 connected to a female housing 60. Male threaded electrical connector 2 of light bulb 1 may be screwed into female threaded electrical connector 59 of mechanical extension 57. It will be appreciate that other inter-engageable electrical connection members may be used.

In accordance with this alternate embodiment, one section of mechanical extension 57 is extendable with respect to another section. For example, female housing 60 and the male housing 58 may include inner and outer cylinders 53, 53a that telescopically slide within each other. A user releasable lock member 56 and telescoping parts may be constructed as discussed with respect to FIGS. 4, 4a and 4b. Two insulated wires may provide a flexible, extendable electrical connection between the two electrically live components of the male a threaded electrical connector 2 and the female threaded electrical connector 59 respectively.

FIGS. 6 and 6a exemplify the use of a fixed length external mechanical extension 62. Mechanical extension 62 may be any member that has a first end removably receivable in a light fixture and a second opposed end that removably receives light bulb 12. As exemplified, the first end may comprise a male threaded electrical connector 2 and the second end may comprise a female threaded electrical connector 63. Two insulated wires or electrically conductive members 64 and 65 provide an electrical connection between the two electrically live components of the male a threaded electrical connector 2 and the female threaded electrical connector 63 respectively.

In accordance with another embodiment, which may be used by itself or with any combination of embodiments disclosed herein, there is provided a power supply 4 that supplies current through LEDs 5 so that LEDs 5 provide illumination but wherein the current does not exceed the maximum current for LEDs 5, over the operating voltage variation in the line current supplied by an external power source (e.g., the AC current provided to a building or lamppost). Preferably, power supply 4 provides sufficient current to provide at least 90% of the maximum possible light at the nominal line voltage of the external power source, without exceeding the maximum current for LEDs 5 over the range of the expected operating voltage variation of the external power source. Several alternate power supplies are exemplified in FIGS. 7, 8 and 9.

A light bulb assembly 1 typically is provided with a line voltage between 105 VAC and 140 VAC in North America, which can also be expressed as a nominal line voltage of 122.5 VAC, +/−17.5 V. In Europe, the light bulb assembly 1, with a different electronics and potentially a different LED mounting printed circuit board 6, typically typically is provided with a line voltage between 192 VAC and 257 VAC, which can also be expressed as nominal line voltage of 225 VAC, +/−32V.

An LED 5 operates on direct current (DC). The design of a light bulb assembly 1 for use in North America or Europe requires an LED light bulb to be chosen to operate over a voltage range of typically +/−14% from its mean operating voltage to match the voltage variation requirements of real world use in North America and Europe thereby eliminating the need for a constant current power supply. A constant current power supply reduces the overall energy efficiency of an LED light bulb assembly 1 and adds size, cost and weight. Accordingly, an LED 5 is designed to operate over a range of voltage and current, which provides a voltage variation of +/− approximately 14%, with a light output variation of +/−14% or less.

One type of the LED 5 chosen to construct one of the preferred embodiments of the instant invention operates between 20-26 ma at a voltage of 3.0 to 3.9 volts and provides a light output which is stable within +/−14% at a current of 18-26 ma. The number of LEDs to be placed in series is chosen by dividing the DC supply voltage by the mean LED voltage and then reducing the number of LEDs by 2-5 and replacing the voltage drop of the LEDs which have been removed by a resistor which serves to protect the LEDs 5 from damage by inrush current when they are turned on. When the number of LEDs is to be reduced, a resistor in series with the LEDs can serve to drop the voltage with an acceptable loss of energy in the form of heat because of the very low current associated with the LEDs, typically 10-100 ma, more preferably 15-50 ma, and most preferably 20-30 ma. As LEDs fail closed circuit, one LED bulb in a series failing will not cause the entire series to lose illumination. On this basis, an LED light bulb assembly 1 operates within a voltage and associated current range, which provides a fairly constant light output without impairing the operating life of the bulbs. A capacitor is wired between the positive and negative output terminals of the bridge rectifier in order to reduce the AC ripple in the DC to below 5 volts, preferably below 2 volts, and most preferable below 0.5 volts as a reduction in the AC ripple enhances the operating life of LEDs 5 and reduces the rate at which they lose light output and change the color spectrum of their output. Inductors reduce the EMI noise from the circuit and prevent resonant oscillation of the LEDs. A sample schematic is shown in FIG. 7.

FIG. 7 exemplifies a first power supply wherein the line voltage (200) is provided from the line source and should be between 110 and 125 volts alternating currant (AC) for North America. The power is then run through a series fuse that must be a slow-blow type to hold during the inrush currant when first turned on. This fuse must be suitably matched for the power required by the circuit as determined by the number of Light Emitting Diodes (LED's) in parallel to the circuit, and after the fuse, an optional varistor (202) can be installed to protect in the event of an over voltage spike such as a lightning strike. The AC power is then rectified by a bridge rectifier (203) to provide direct currant (DC) to the LED's. A series resistor (204) is used to limit the inrush currant to the capacitor 205. The first capacitor (205) is used to filter the AC component from the DC power to extend the life of the LED's and reduce flickering. This capacitor is to be matched to the power requirements of the LED's. A resistor (206) is placed in parallel to the first capacitor (205) to discharge the capacitor when the voltage source is disconnected. The second capacitor (207) is used to filter high frequency that is often present on the AC mains and cannot be filtered by the diodes. The remaining voltage is dropped across a series of LED's. The number of LED's is determined by voltage drop of the LED it's self and the line voltage.

FIG. 8 shows an alternative schematic for a power supply for LED light bulbs wherein a capacitor is employed to drop the voltage provided to a bridge rectifier, which converts the AC to DC. A capacitor between the positive and negative output terminals of the bridge rectifier in order to reduce the AC ripple in the DC to below 5 volts, preferably below 2 volts, and most preferable below 0.5 volts as a reduction in the AC ripple enhances the operating life of LEDs 5 and reduces the rate at which they lose light output and change the color spectrum of their output. Inductors reduce the EMI noise from the circuit and prevent resonant oscillation of the LEDs.

As exemplified in the alternate embodiment of FIG. 8, the line voltage (210) is provided from the AC mains. The power is then passed through the slow-blow fuse (211). The AC power is then passed through a non-polarized capacitor (212) that through reactive capacitance reduces the voltage. A resistor (213) is placed in parallel to the capacitor (212) to dissipate the power when the mains are disconnected. This will reduce the likelihood of a shock when disengaged from the socket. The power is then rectified by the bridge rectifier (215) providing DC power to the rest of the circuit. The DC power is then limited by the resistor (216) so that the inrush currant does not exceed the capabilities of the fuse (211). The DC power is then filtered by the capacitor (217) by reducing the AC component and thereby extending the life of the LED's. A resistor (218) is placed in parallel to the capacitor (217) to discharge the circuit when the mains are removed. A second capacitor (219) is added in parallel to filter the high frequency noise that is often present on the AC mains and cannot be filtered by the diodes in the bridge rectifier (215). The remaining voltage is dropped across the series LED's (220) or combination of series and parallel LED's. The number of LED's required will be determined by the power provided from the capacitor (212) or vise versa.

FIG. 9 shows a further alternate schematic for a power supply for LED light bulbs wherein a resistor is wired in series of the LED light bulbs 5 in order to reduce the voltage, which is applied to them to enable bulbs to be constructed with smaller numbers of bulbs. A capacitor between the positive and negative output terminals of the bridge rectifier in order to reduce the AC ripple in the DC to below 5 volts, preferably below 2 volts, and most preferable below 0.5 volts as a reduction in the AC ripple enhances the operating life of LEDs 5 and reduces the rate at which they lose light output and change the color spectrum of their output. Inductors reduce the EMI noise from the circuit and prevent resonant oscillation of the LEDs.

As exemplified in the further alternate embodiment of FIG. 9, the line voltage (230) being provided from the AC mains. The power is then passed through the slow-blow fuse (231). A resistor (232) is then used to reduce the voltage to the remainder of the circuit. The power is then rectified by the bridge rectifier (233) providing DC power to the rest of the circuit. The DC power is then limited by the resistor (234) so that the inrush currant does not exceed the capabilities of the fuse (231). The DC power is then filtered by the capacitor (235) by reducing the AC component and thereby extending the life of the LED's. A resistor (236) is placed in parallel to the capacitor (235) to discharge the circuit when the mains are removed. A second capacitor (237) is added in parallel to filter the high frequency noise that is often present on the AC mains and cannot be filtered by the diodes in the bridge rectifier (233). The remaining voltage is dropped across the series LED's (238) or combination of series and parallel LED's. The number of LED's required will be determined by the power provided from the resistor (232) or vise versa. In addition an optional inductor (239) can be added to the circuits to reduce the AC ripple on LED's further.

Many compact fluorescent light bulbs provide a color temperature of 3200K to 5000K, which represents a color range referred to as “soft white” to “sunlight”. In accordance with another embodiment, which may be used by itself or with any combination of embodiments disclosed herein, it has surprising been determined that a color temperature closer to that of the sky rather than that of the sun is a better color for people to work under. This color range produces less glare as the wavelengths of light produced tend to pass into the clear coatings on magazines and reflect in a more dispersed manner. Therefore, the LED light bulbs, either individually or in combination of their total frequencies, preferably produce an average or mean color temperature of 5700K to 20,000K, more preferably 6500K to 12,500K, and most preferably about 8500-10500K.

In accordance with another embodiment, which may be used by itself or with any combination of embodiments disclosed herein, an alternate construction for LEDs is provided. A typical LED light bulb is shown in FIG. 15a. The LED bulb to be incorporated into the preferred embodiments of this invention preferably have a reduced amount to plastic lens material in front of the semiconductor crystal as shown in FIG. 15b thereby increasing the light output and reducing the amount of light that is absorbed by the plastic. As exemplified, the plastic housing preferably has a length L between the crystal 5a of LED 5 and the distal tip of LED 5 that is less than 0.5″, preferably less than 0.375″, more preferably less than 0.25″ and most preferably about 0.125″. For example, length L may be about 0.5-0.09″, preferably 0.375-0.125″ and more preferably 0.25-0.125″.

Alternately, or in addition, as exemplified in FIG. 15c, LED 5 chosen for the light bulb assembly 1 have a narrow light output angle A of 15-75 degrees for spot light applications, more preferably 25-60 degrees and most preferably 34-45 degrees.

Alternately, or in addition, as exemplified in FIG. 15d, LED 5 chosen for the bulb assembly 1 have a wide light output angle A of 75-150 degrees for flood lighting applications, more preferably 90-120 degrees and most preferably 100-110 degrees.

Furthermore, in a particular embodiment, light bulbs for specialty lighting may incorporate LED bulbs of different angles. For example, the LEDs 5 mounted on the perimeter of the bulb 1 may be wide angle, e.g., 75-150 degrees, to generally illuminate an area while the interior mounted LEDs 5 are narrow angle, e.g. as per the preferred angles used for spot light applications, thereby creating spot illumination such as for a sign or display.

In accordance with another embodiment, which may be used by itself or with any combination of embodiments disclosed herein, the outer surface 47 on the face of the front cover 7 is preferably made of a highly reflective material. Preferably, surface 47 is coated with a layer of aluminum, silver, chrome, or another visible light reflective material including glass microspheres (microbeads) deposited onto or affixed onto or molded into the plastic of the front cover 7, which is preferably made of a white plastic for normal lighting.

In accordance with this alternate embodiment, if lighting with a colored hue is desired, it is preferable to deposit a layer of aluminum onto surface 47 and mold the front cover 7 in a colored plastic so that the reflected light has a colored appearance. For instance, a yellow molded plastic color in the front cover 7 will result in a golden hue to the light. Similarly, a blue molded plastic color in the front cover 7 will result in a blue hue to the light.

A vapor deposited layer of aluminum or silver is preferably coated with a transparent weather and UV resistant paint, and/or one or more layers of silicone monoxide adjacent to the aluminum or one or more layers of silicon dioxide (SiO and/or SiO₂) to prevent weather damage and oxidation of the visible light reflective coating, and/or one or more layers of transparent ink.

In accordance with another embodiment, which may be used by itself or with any combination of embodiments disclosed herein, the light bulb 1 is sealed. In particular, one or more seal members that are associated with at least one of LED5, cover 7 and board 6 to seal board 6 while permitting the distal end of LEDs5 to be exposed to the environment (i.e., there is no cover member surrounding all of LEDs 5). Several alternate embodiments are exemplified in FIGS. 10 and 10a, 11 and 11a, 12 and 12a, 13 and 13a, and 14 and 14a.

FIGS. 10 and 10a exemplify an alternative preferred embodiment wherein a series of individual O-rings 66 made of, e.g., silicone, EPDM or other flexible weather resistant plastic or rubber are installed to seal around each of the LED bulbs 5 to create a weather tight seal between the LED bulbs 5 and surface 47 of front cover 7. This essentially seals the interior of the bulb assembly 1 from the outside environment. FIGS. 11 and 11a exemplify an alternative preferred embodiment wherein a series of O-rings 67 are molded as an assembly.

FIGS. 12 and 12a exemplify an alternative preferred embodiment wherein a layer of silicone or other flexible compressible weather resistant material 68 is pressed over the LEDs 5 to create a weather tight seal between the LED bulbs 5 and the front cover 7 and between front cover 7 and board 6. Accordingly, two different seals are created.

FIGS. 13 and 13a exemplify an alternative preferred embodiment wherein a series of holes 70 whose position corresponds to the positions of the LED 5 positions on the LED mounting printed circuit board 6 are stamped out of a layer of, e.g., closed cell foam or silicone, to which an adhesive may be applied on both major faces to create an adhesive sealing gasket 69. The adhesive sealing gasket 69 serves to create a weather tight seal between the printed circuit board 6, and the front cover 7. The adhesive sealing gasket 69 may optionally seal around each of the individual LEDs 5.

FIGS. 14 and 14a exemplify an alternative preferred embodiment wherein a series of holes 74 whose position corresponds to the positions of the wires of LEDs 5 on the LED mounting printed circuit board 6 are stamped out of a layer of, e.g., closed cell foam or silicone, to which an adhesive may be applied on both major faces to create an adhesive sealing gasket 73. The adhesive sealing gasket 69 serves to create a weather tight seal between the printed circuit board 6, and LEDs 5.

In any such embodiment, a seal is also provided between the outer perimeter of front cover 7 and main body 3. Accordingly, the lens of LEDs 5 may be exposed to the environment while board 6 is sealed against, e.g., rain. An advantage of this design is that the LED's are at least partially exposed to the atmosphere and may therefore operate at a cooler temperature. In addition, less light is lost as all of the light does not have to be transmitted through a cover overlying the LEDs.

In accordance with another embodiment, which may be used by itself or with any combination of embodiments disclosed herein, different parts of light bulb 1 may be constructed from different colour materials. For example, front cover 7 and main body 3 may be made from different colour plastics. An advantage of this design is that it a misalignment of parts will be more apparent.

It will be appreciated that certain features of the invention, which are, for clarity, described in the context of separate embodiments or separate aspects, may also be provided in combination in a single embodiment. Conversely, various features of the invention, which are, for brevity, described in the context of a single embodiment or aspect, may also be provided separately or in any suitable sub-combination.

The embodiment of a LED light bulb comprising a housing construction that uses a thin wall material may be used with one or more of EMI shielding, a mechanical member the extends outward of the longitudinal extent of the LEDs to thereby protect the LEDs, a construction for facilitating the mechanical gripping of the light bulb for installation and removal, a construction to enable the end of the light bulb containing the LEDs to seat at the desired position in a light bulb receptacle, the use of at least one LED selected based upon the operating voltage, beam angle of light output and/or color temperature of the LED, a power supply that provides sufficient current such that the LEDs provide at least 90% of their maximum light output at nominal line voltage, a front cover reflector, and a LED light bulb comprising a construction to seal the light bulb from water ingress and permitting at least a portion of the LEDs to be exposed to the environment.

The embodiment of a LED light bulb using EMI shielding may be used with one or more of a LED light bulb comprising a housing construction that uses a thin wall material, a mechanical member the extends outward of the longitudinal extent of the LEDs to thereby protect the LEDs, a construction for facilitating the mechanical gripping of the light bulb for installation and removal, a construction to enable the end of the light bulb containing the LEDs to seat at the desired position in a light bulb receptacle, the use of at least one LED selected based upon the operating voltage, beam angle of light output and/or color temperature of the LED, a power supply that provides sufficient current such that the LEDs provide at least 90% of their maximum light output at nominal line voltage, a front cover reflector, and a LED light bulb comprising a construction to seal the light bulb from water ingress and permitting at least a portion of the LEDs to be exposed to the environment.

The embodiment of a LED light bulb using a mechanical member the extends outward of the longitudinal extent of the LEDs to thereby protect the LEDs may be used with one or more of EMI shielding, a LED light bulb comprising a housing construction that uses a thin wall material, a construction for facilitating the mechanical gripping of the light bulb for installation and removal, a construction to enable the end of the light bulb containing the LEDs to seat at the desired position in a light bulb receptacle, the use of at least one LED selected based upon the operating voltage, beam angle of light output and/or color temperature of the LED, a power supply that provides sufficient current such that the LEDs provide at least 90% of their maximum light output at nominal line voltage, a front cover reflector, and a LED light bulb comprising a construction to seal the light bulb from water ingress and permitting at least a portion of the LEDs to be exposed to the environment.

The embodiment of a LED light bulb using a construction for facilitating the mechanical gripping of the light bulb for installation and removal may be used with one or more of EMI shielding, a LED light bulb comprising a housing construction that uses a thin wall material, a mechanical member the extends outward of the longitudinal extent of the LEDs to thereby protect the LEDs, a construction to enable the end of the light bulb containing the LEDs to seat at the desired position in a light bulb receptacle, the use of at least one LED selected based upon the operating voltage, beam angle of light output and/or color temperature of the LED, a power supply that provides sufficient current such that the LEDs provide at least 90% of their maximum light output at nominal line voltage, a front cover reflector, and a LED light bulb comprising a construction to seal the light bulb from water ingress and permitting at least a portion of the LEDs to be exposed to the environment.

The embodiment of a LED light bulb using a construction to enable the end of the light bulb containing the LEDs to seat at the desired position in a light bulb receptacle may be used with one or more of EMI shielding, a LED light bulb comprising a housing construction that uses a thin wall material, a mechanical member the extends outward of the longitudinal extent of the LEDs to thereby protect the LEDs, a construction for facilitating the mechanical gripping of the light bulb for installation and removal, the use of at least one LED selected based upon the operating voltage, beam angle of light output and/or color temperature of the LED, a power supply that provides sufficient current such that the LEDs provide at least 90% of their maximum light output at nominal line voltage, a front cover reflector, and a LED light bulb comprising a construction to seal the light bulb from water ingress and permitting at least a portion of the LEDs to be exposed to the environment.

The embodiment of a LED light bulb using the use of at least one LED selected based upon the operating voltage, beam angle of light output and/or color temperature of the LED may be used with one or more of EMI shielding, a LED light bulb comprising a housing construction that uses a thin wall material, a mechanical member the extends outward of the longitudinal extent of the LEDs to thereby protect the LEDs, a construction for facilitating the mechanical gripping of the light bulb for installation and removal, a construction to enable the end of the light bulb containing the LEDs to seat at the desired position in a light bulb receptacle, a power supply that provides sufficient current such that the LEDs provide at least 90% of their maximum light output at nominal line voltage, a front cover reflector, and a LED light bulb comprising a construction to seal the light bulb from water ingress and permitting at least a portion of the LEDs to be exposed to the environment.

The embodiment of a LED light bulb using a power supply that provides sufficient current such that the LEDs provide at least 90% of their maximum light output at nominal line voltage may be used with one or more of EMI shielding, a LED light bulb comprising a housing construction that uses a thin wall material, a mechanical member the extends outward of the longitudinal extent of the LEDs to thereby protect the LEDs, a construction for facilitating the mechanical gripping of the light bulb for installation and removal, a construction to enable the end of the light bulb containing the LEDs to seat at the desired position in a light bulb receptacle, the use of at least one LED selected based upon the operating voltage, beam angle of light output and/or color temperature of the LED, a front cover reflector, and a LED light bulb comprising a construction to seal the light bulb from water ingress and permitting at least a portion of the LEDs to be exposed to the environment.

The embodiment of a LED light bulb using a front cover with a reflective outer surface may be used with one or more of EMI shielding, a LED light bulb comprising a housing construction that uses a thin wall material, a mechanical member the extends outward of the longitudinal extent of the LEDs to thereby protect the LEDs, a construction for facilitating the mechanical gripping of the light bulb for installation and removal, a construction to enable the end of the light bulb containing the LEDs to seat at the desired position in a light bulb receptacle, the use of at least one LED selected based upon the operating voltage, beam angle of light output and/or color temperature of the LED, a power supply that provides sufficient current such that the LEDs provide at least 90% of their maximum light output at nominal line voltage, and a LED light bulb comprising a construction to seal the light bulb from water ingress and permitting at least a portion of the LEDs to be exposed to the environment.

The embodiment of a LED light bulb comprising a construction to seal the light bulb from water ingress and permitting at least a portion of the LEDs to be exposed to the environment may be used with one or more of EMI shielding, a LED light bulb comprising a housing construction that uses a thin wall material, a mechanical member the extends outward of the longitudinal extent of the LEDs to thereby protect the LEDs, a construction for facilitating the mechanical gripping of the light bulb for installation and removal, a construction to enable the end of the light bulb containing the LEDs to seat at the desired position in a light bulb receptacle, the use of at least one LED selected based upon the operating voltage, beam angle of light output and/or color temperature of the LED, a power supply that provides sufficient current such that the LEDs provide at least 90% of their maximum light output at nominal line voltage, and a front cover with a reflective outer surface.

Although the invention has been described in conjunction with specific embodiments thereof, if is evident that many alternatives, modifications and variations will be apparent to those skilled in the art. Accordingly, it is intended to embrace all such alternatives, modifications and variations that fall within the spirit and broad scope of the appended claims. In addition, citation or identification of any reference in this application shall not be construed as an admission that such reference is available as prior art to the present invention.

1. A LED light bulb for receipt in a light housing, the housing having an electrical connector end and a rim defining an opening for receiving the LED light bulb, the LED light bulb comprising:
(a) an electrical connector end;
(b) a second end comprising at least one LED; and,
(c) an adjustment member operable to adjust the position of the second end with respect to the rim of the housing.

2. The LED light bulb of claim 1 wherein the adjustment member comprises a separate removable member wherein the separate removable member has a first end adapted to be electrically engageable with the electrical connector end of the LED light bulb and a second end adapted to be electrically engageable with the electrical connector end of the housing.

3. The LED light bulb of claim 1 wherein the electrical connector end of the housing comprises a threaded member and the electrical connector end of the LED light bulb has a mating thread.

4. The LED light bulb of claim 2 wherein the first end of the separate removable member is threaded and the electrical connector end of the LED light bulb has a mating thread.

5. The LED light bulb of claim 1 wherein the adjustment member comprises a longitudinally extendable section of the LED light bulb.

6. The LED light bulb of claim 5 wherein the longitudinally extendable section is a telescoping section.

7. The LED light bulb of claim 5 further comprising electrical conduits extending between the electrical connector end of the LED light bulb and the second end of the LED light bulb wherein the electrical conduits are extendable.

8. The LED light bulb of claim 5 further comprising electrical conduits extending between the electrical connector end of the LED light bulb and the second end of the LED light bulb wherein the electrical conduits have a length sufficient to permit the longitudinally extendable section to extend.

9. The LED light bulb of claim 1 wherein the LED light bulb is extendable to seat the second end adjacent the rim of the housing when in an extended position.

10. A LED light bulb comprising at least one LED wherein the light bulb produces a color temperature of 5,700K to 20,000K.

11. The LED light bulb of claim 10 wherein the at least one LED produces a color temperature of 6,500K to 12,500K.

12. The LED light bulb of claim 10 wherein the at least one LED produces a color temperature of 8,500-10,500K.

13. The LED light bulb of claim 10 further comprising a plurality of LEDs.

14. The LED light bulb of claim 13 wherein the mean color temperature produced by the LEDs is 5,700K to 20,000K.

15. The LED light bulb of claim 10 wherein the mean color temperature produced by the LEDs is 6,500K to 12,000K.

16. The LED light bulb of claim 10 wherein the mean color temperature produced by the LEDs is 8,500-10,500K.
